(19) United States
(12) Patent Application Publication
(10) Pub. No.: US 2009/0147952 A1
(43) Pub. Date: Jun. 11, 2009

(54) SYSTEM AND METHOD FOR THE DISPLAY OF SCREEN APPARATUS CONTENT OVERLAYED ON PROTECTED CONTENT

(76) Inventors: Brian David Johnson, Portland, OR (US); C. Brendan S. Traw, Portland, OR (US)

Correspondence Address: Molly A. McCall;Intel Corporation, c/o Intellevate, L.L.C., P.O. Box 52050, Minneapolis, MN, 55402, US

(21) Appl. No.: 11/954,041

(22) Filed: Dec. 11, 2007

(51) Int. Cl. H04N 7/167

(52) U.S. Cl. 380/205

(57) ABSTRACT

A system and method for the display of screen apparatus content overlayed on protected content is described. An embodiment of a system may include a device connected to a network. The device receives and stores screen apparatus content. The device also receives protected content that is not being altered by a user. The device displays the stored screen apparatus content overlayed on the protected content via a user interface on a display device without altering the protected content by the user. Other embodiments are described and claimed.

### BACKGROUND

Today's homes may have one or more electronic devices that receive, process and/or store content, such as personal computers (PCs), televisions, digital video disk (DVD) players, video cassette recorder (VCR) players, compact disk (CD) players, set-top boxes (STBs), stereo receivers, audio/video receivers (AVRs), media centers, personal video recorders (PVRs), gaming devices, digital camcorders, digital cameras, and so forth. These all may be networked together in such a way to provide a user with a means for entertainment via the entertainment center and a single display device.

At times, two or more types of content available in such a network may not be displayed on the single display device at the same time. One such example involves broadcasted content. Broadcasted content is typically protected and asynchronous video. Thus, a user is unable to modify the broadcasted content to allow for another type of content to be displayed at the same time on a single display device.

### BRIEF DESCRIPTION OF THE DRAWINGS

FIG. 1 illustrates one embodiment of a user interface.

FIG. 2 illustrates one embodiment of a system.

FIG. 3 illustrates one embodiment of a system.

FIG. 4 illustrates one embodiment of a logic flow.

FIG. 5 illustrates one embodiment of a device.

### DETAILED DESCRIPTION

Various embodiments may be generally directed to a system and method for the display of screen apparatus content overlayed on protected content. An example of screen apparatus content is any content received and stored on a device connected to a network. In embodiments, a screen apparatus may be any content or information or graphics (e.g., audio, video or graphics signal) that is overlayed or blended with another content or information or graphics (e.g., audio, video or graphics signal). Example screen apparatus content may include internet protocol (IP) delivered content or Universal Serial Bus (USB) delivered content. Protected content is content that is not being altered by a user. One example of protected content is broadcast content. Broadcast content is protected and asynchronous content. Embodiments of the invention allow a user to blend screen apparatus content (e.g., IP delivered content or USB delivered content) and protected content (e.g., broadcast content) in such a way that both types of content may be displayed at the same time on a single display device without the user altering the protected content. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

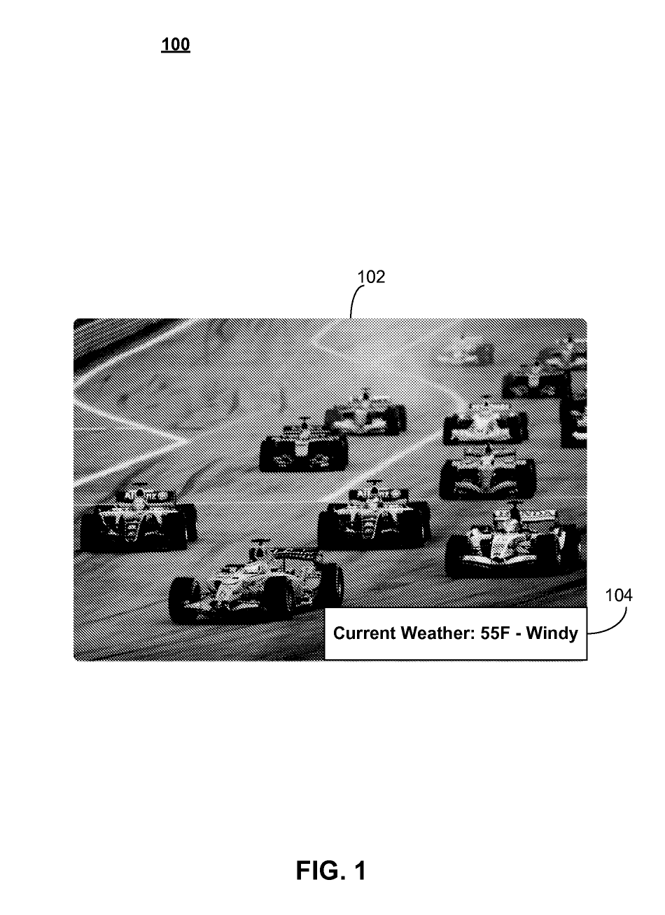

FIG. 1 illustrates one embodiment of a user interface 100. User interface 100 may comprise a protected content section 102 and a screen apparatus content section 104. User interface 100 may be displayed on a display device, for example. Although FIG. 1 is illustrated as having one screen apparatus content section, this is not meant to limit the invention. User interface 100 may include multiple screen apparatus content sections. Each of these sections is described next in more detail.

In embodiments, protected content section 102 displays any content that is not being altered by a user. The protected content may be broadcasted, received via cable or satellite feeds, pre-recorded and stored on a digital recording device (such as a personal video recorder (PVR)), streamed or downloaded via the Internet via an IP connection, stored on a home local area network (LAN), received via various types of video interconnects (e.g., Video Graphics Array (VGA), High-Definition Multimedia Interface (HDMI), component video, composite video, etc.), and so forth. The protected content displayed in section 102 may include shows or programs, graphics, video games, books, video shorts, video previews, news clips, news highlights, and so forth. Related voice, audio, music, etc., may also be presented with the displayed content in section 102.

In embodiments, screen apparatus content section 104 displays any content that may be received by a device connected to a network, such as a home entertainment network. In embodiments, a screen apparatus may be any content or information or graphics (e.g., audio, video or graphics signal) that is overlayed or blended with another content or information or graphics (e.g., audio, video or graphics signal). In embodiments, the screen apparatus content may be streamed or downloaded to the connected device from the Internet via an IP connection or content received via any USB device connection. The screen apparatus content may be any type of content including, but not limited to, images, video, text, graphical elements, and so forth. The screen apparatus content may be content that is dynamic or constantly updated via an IP delivered site, system or service or via a USB device, for example. Examples of the types of information provided by the screen apparatus content may include a stock ticker, fantasy sports updates, weather, traffic reports, news, etc., although embodiments of the invention are not limited to these examples. Related voice, audio, music, etc., may also be presented with the screen apparatus content in section 104.

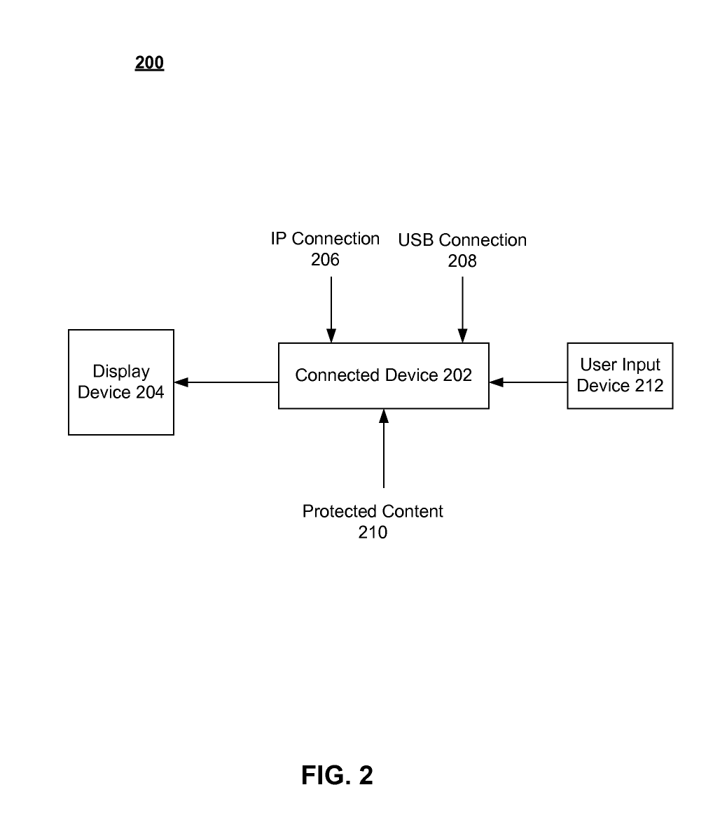

Referring to FIG. 2, an example embodiment of a system 200 illustrating a connected device 202 is shown. The screen apparatus content may be stored on the connected device's hard drive or other storage. Connected device 202 may be the source of protected content 210. Connected device 202 may also be a pass-through device for protected content 210 where another source (e.g., STB, DVR, etc.) supplies protected content 210 and connected device 202 applies or overlays the screen apparatus content on protected content 210. The screen apparatus content may be streamed or downloaded to the connected device from the Internet via an IP connection 206 or content received via any USB device connection 208 in the network. User interface 100 may be displayed on display device 204. A television may be an example display device 204.

Referring back to FIG. 1, user interface 100 illustrates one display format where screen apparatus content section 104 is smaller in size than protected content section 102 and positioned on the lower right hand area of user interface 100. Embodiments of the invention are not limited to the display format illustrated in FIG. 1. In fact, embodiments of the invention allow the user to customize the content displayed in section 104 and to customize the position and size of section 104 in user interface 100. Here, the user may download a program element to connected device 202 from an IP delivered site or service or from a USB device (for example) that allows the user to customize section 104 to reflect user preferences. The customization of section 104 may include both the screen apparatus content displayed in section 104 and the size and location of section 104 on user interface 100.

In embodiments, the user may use connected device 202 to overlay or blend the stored screen apparatus content with protected content 210 on the single display device 204 without altering protected content 210. In embodiments, the protected content may be decoded and then re-encoded with the screen apparatus content. In embodiments, the overlay or blending of the screen apparatus and protected content may be a hardware-enabled overlay or blend via a microprocessor, chipset, graphics card, etc. In other embodiments, the overlay or blending of the screen apparatus and protected content may be a software-enabled overlay or blend via a specific application, operating system, etc. In yet other embodiments, the overlay or blending may be via a combination of hardware and/or software components. In addition, there may be some overlay or blending in the pipes themselves or via another method while the content is in route to the screen. This may be implemented with wireless connection technology, wired connection technology, or a combination of both.

The user may customize or configure user interface 100 directly on connected device 202 or via a user input device 212 such as a remote control or personal computer (PC), for example.

In embodiments, system 200 may be implemented as a wireless system, a wired system, or a combination of both.

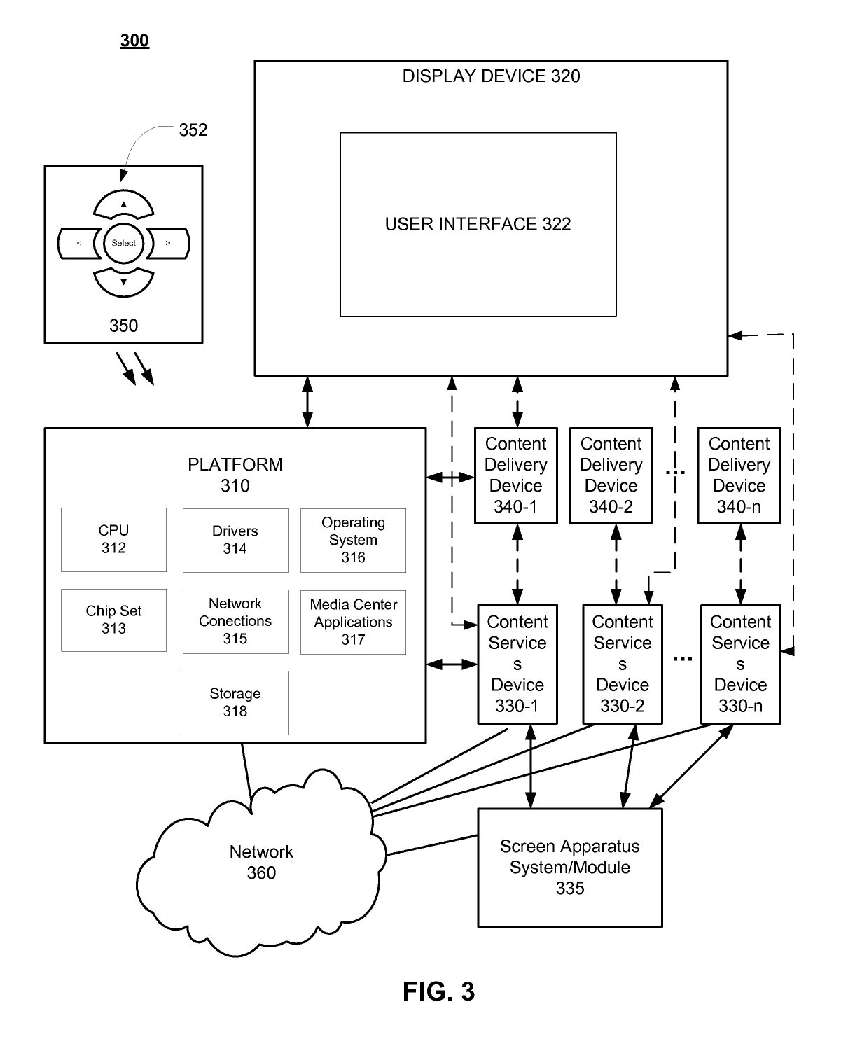

FIG. 3 illustrates one embodiment of a system 300 in which embodiments of the invention may be implemented. In one embodiment, system 300 may be a digital home entertainment system although system 300 is not limited in this context. In one embodiment, system 300 comprises a platform 310 (e.g., connected device 202 in FIG. 2) coupled to a display device 320. In one embodiment, platform 310 may comprise or may be implemented as a media platform such as the Viiv™ media platform made by Intel® Corporation. In one embodiment, platform 310 may receive content from one or more content devices such as content services devices 330 (330-1 to 330-m, where m is any positive integer) or one or more content delivery devices 340 (340-1 to 340-p, where p is any positive integer) or other similar content source. In an embodiment of the invention, one or more of content services devices 330 may be hosted by any national, international and/or independent service and thus accessible to platform 310 via the Internet. One or more of content services devices 330 may be coupled to platform 310 and/or to display device 320. Platform 310 and/or content services devices 330 may be coupled to a network 360 to communicate (e.g., send and/or receive) media information to and from network 360. One or more of content delivery devices 340 also may be coupled to platform 310 and/or to display device 320.

In various embodiments, one or more of content services devices 330 may be coupled (e.g., either directly or via network 360) to a screen apparatus system/module 335. Screen apparatus system/module 335 may contain one or more software applications to perform the functionality of the invention as described herein. Screen apparatus system/module 335 may utilize the content and/or service providers to provide screen apparatus content to platform 310 and/or to allow a user to customize the screen apparatus content or display. The functionality of screen apparatus system/module 335 may also be integrated directly in platform 310.

Content and/or service providers may utilize one or more of content services devices 330 to provide services and/or products to a user via user interface 322 (e.g., user interface 100 in FIG. 1).

In various embodiments, platform 310 and one or more of content services devices 330 may be integrated, or platform 310 and one or more of content delivery devices 340 may integrated, or platform 310, one or more of content services devices 330, and one or more of content delivery devices 340 may be integrated, for example. In various embodiments, platform 310 and display device 320 may be an integrated unit and display device, or one or more of content service devices 330 may be integrated, or display device 320 and one or more of content delivery devices 340 may integrated. A navigation controller 350 comprising one or more navigation buttons 352 may be used to interact with either platform 310 or display device 320, and/or both, for example.

In one embodiment, platform 310 may comprise a CPU 312, a chip set 313, one or more drivers 314, one or more network connections 315, an operating system 316, and/or media center applications 317 comprising one or more software applications, for example. Platform 310 also may comprise storage 318. Storage 318 may include the screen apparatus content and any downloaded program element from screen apparatus system/module 335 or any other IP delivered site or service or from a USB device (for example) that allows the user to customize the screen apparatus content and/or user interface 322 to include user preferences.

In one embodiment, CPU 312 may comprise one or more processors such as dual-core processors. Examples of dual-core processors include the Pentium® D processor and the Pentium® processor Extreme Edition both made by Intel® Corporation, which may be referred to as the Intel Core Duo® processors, for example.

In one embodiment, chip set 313 may comprise any one of or all of the Intel® 945 Express Chipset family, the Intel® 955X Express Chipset, Intel® 975X Express Chipset family, plus ICH7-DH or ICH7-MDH controller hubs, which all are made by Intel® Corporation.

In one embodiment, drivers 314 may comprise the Quick Resume Technology Drivers made by Intel® to enable users to instantly turn on and off platform 310 like a television with the touch of a button after initial boot-up, when enabled, for example. In addition, chip set 313 may comprise hardware and/or software support for 3.1 surround sound audio and/or high definition 7.1 surround sound audio, for example. Drivers 314 may include a graphics driver for integrated graphics platforms. In one embodiment, the graphics driver may comprise a peripheral component interconnect (PCI) Express graphics card.

In one embodiment, network connections 315 may comprise the PRO/1000 PM or PRO/100 VE/VM network connection, both made by Intel® Corporation.

In one embodiment, operating system 316 may comprise the Windows® XP Media Center made by Microsoft® Corporation. In one embodiment, one or more media center applications 317 may comprise a media shell to enable users to interact with content using navigation controller 350 (e.g., remote control) from a distance of about 10-feet away from platform 310 or display device 320, for example. In one embodiment, the media shell may be referred to as a “10-feet user interface,” for example. In addition, one or more media center applications 317 may comprise the Quick Resume Technology made by Intel®, which allows instant on/off functionality and may allow platform 310 to stream content to media adaptors or other content services devices 330 or content delivery devices 340 when the platform is turned “off.”

In one embodiment, storage 318 may comprise the Matrix Storage technology made by Intel® to increase the storage performance enhanced protection for valuable digital media when multiple hard drives are included.

In one embodiment, display device 320 may comprise any television type monitor or display. Display device 320 may comprise, for example, a computer display screen, video monitor, television-like device, and/or a television. Display device 320 may be digital and/or analog.

In various embodiments, one or more of content services devices 330 may comprise a cable television box, personal computer, network, telephone, Internet enabled devices or appliance capable of delivering digital information and/or content, and any other similar device capable of unidirectionally or bidirectionally communicating content between content providers and platform 310 and/display device 320, via network 360. It will be appreciated that the content may be communicated unidirectionally and/or bidirectionally to and from any one of the components in system 300 and a content provider via network 360. Examples of content may include any media information including, for example, video, music, and gaming information. One or more of content services devices 330 may receive content such as cable television programming including media information, digital information, and/or other content. Examples of content providers may include any cable or satellite television or radio content providers and may include, for example, ESPN, Movielink, and MTV Overdrive for video; Napster, AOL and Tiscali for music; Gametap, Square Enix and T-Online for gaming; and YouTube and Flickr for sharing services.

In various embodiments, one or more of content delivery devices 340 may comprise a DVD player, CD player, DVR, video game, digital video camera, digital still camera, and/or MP3 (MPEG-1 Audio Layer 3 where MPEG stands for Moving Pictures Experts Group) player, among others, for example.

Platform 310 may receive content from network 360 directly or via one or more of content services devices 330. Platform 310 may receive content from one or more of content delivery devices 340. Under the control of one or more software applications, such as media center application 317, platform 310 displays user interface 322 (e.g., user interface 100) on display device 320.

In various embodiments, system 300 may be implemented as a wireless system, a wired system, or a combination of both. When implemented as a wireless system, system 300 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 300 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 310 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 3.

Operations for the above embodiments may be further described with reference to the following figure and accompanying examples. The figure includes a logic flow. It can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof.

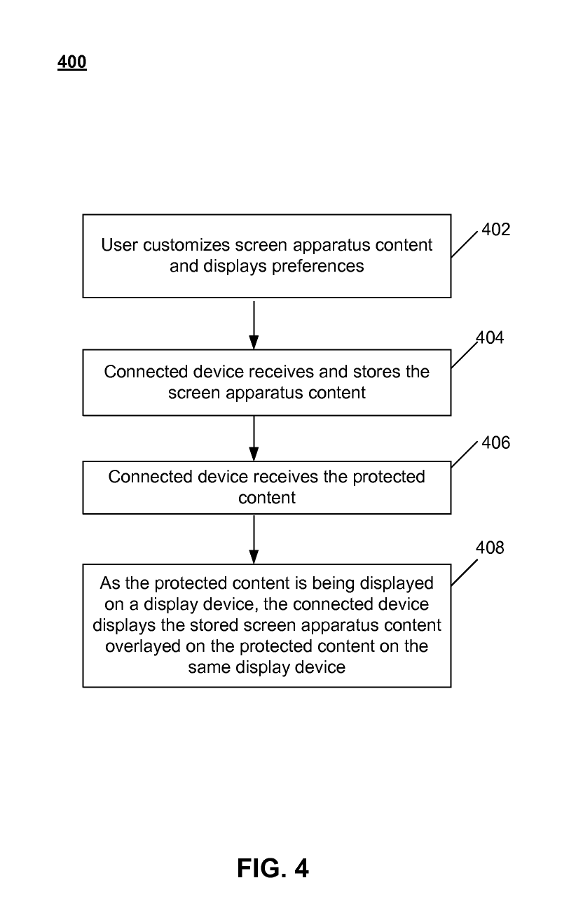

FIG. 4 illustrates one embodiment of a logic flow 400. The logic flow 400 may be representative of the operations executed by one or more embodiments described herein, for example, the operations executed by system 200 or system 300. In one embodiment, logic flow 400 may be representative of the operations executed by a processor (e.g., the CPU 312) under the control of one more software applications (e.g., media center applications 317).

As shown in logic flow 400, a user customizes screen apparatus content and displays preferences (block 402). As discussed above, the user may download a program element to a connected device (such as device 202 from FIG. 2 or platform 310 from FIG. 3). The user may then use the downloaded program element to customize the screen apparatus content and the display format of the screen apparatus content on a user interface (such as user interface 100 from FIG. 1).

The connected device receives and stores the screen apparatus content (block 404). In embodiments, the screen apparatus content may be streamed or downloaded to the connected device from the Internet via an IP connection or content received via any USB connection. The screen apparatus content may be any type of content including, but not limited to, images, video, text, and graphical elements. The screen apparatus content may be content that is dynamic or constantly updated via an IP delivered site, system or service or a USB device, for example. Here, the connected device receives and stores the updated screen apparatus content as it is being received.

The connected device receives the protected content (block 406). Protected content may be any content that is not being altered by a user. The protected content may be broadcasted, received via cable or satellite feeds, pre-recorded and stored on a digital recording device (such as a personal video recorder (PVR)), streamed or downloaded via the Internet via an IP connection, stored on a home local area network (LAN), received via various types of video interconnects (e.g., Video Graphics Array (VGA), High-Definition Multimedia Interface (HDMI), component video, composite video, etc.), and so forth. The protected content may include shows or programs, graphics, video games, books, video shorts, video previews, news clips, news highlights, and so forth.

The connected device may be the source of the protected content (e.g, directly receiving broadcast content from the broadcast provider). The connected device may also be a pass-through device for the protected content where another source (e.g., STB, DVR, etc.) supplies the protected content to the connected device.

It is important to note that blocks 404 and 406 operate in parallel with each other in embodiments of the invention.

As the protected content is being displayed on a display device, the connected device displays the stored screen apparatus content overlayed on the protected content on the same display device without altering the protected content (block 408). In embodiments, the overlay or blending of the screen apparatus and protected content may be a hardware-enabled overlay or blend via a microprocessor, chipset, graphics card, etc. In other embodiments, the overlay or blending of the screen apparatus and protected content may be a software-enabled overlay or blend via a specific application, operating system, etc. In yet other embodiments, the overlay or blending may be via a combination of hardware and/or software components. In addition, there may be some overlay or blending in the pipes themselves or via another method while the content is in route to the screen. This may be implemented with wireless connection technology, wired connection technology, or a combination of both. How the screen apparatus content is displayed with the protected content in the user interface may be customized by the user.

The embodiments, however, are not limited to the elements or in the context shown or described in FIG. 4.

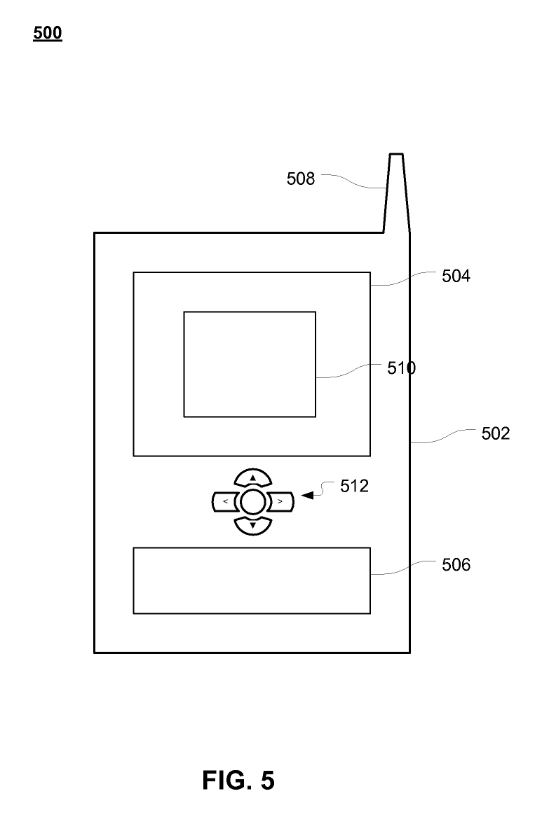

FIG. 5 illustrates one embodiment of a device 500 in which functionality of the present invention as described herein may be implemented. In one embodiment, for example, device 500 may comprise a communication system. In various embodiments, device 500 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, and so forth. The embodiments are not limited in this context.

In one embodiment, device 500 may be implemented as part of a wired communication system, a wireless communication system, or a combination of both. In one embodiment, for example, device 500 may be implemented as a mobile computing device having wireless capabilities. A mobile computing device may refer to any device having a processing system and a mobile power source or supply, such as one or more batteries, for example.

Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth.

In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 5, device 500 may comprise a housing 502, a display 504, an input/output (I/O) device 506, and an antenna 508. Device 500 also may comprise a five-way navigation button 512. I/O device 506 may comprise a suitable keyboard, a microphone, and/or a speaker, for example. Display 504 may comprise any suitable display unit for displaying information appropriate for a mobile computing device. I/O device 506 may comprise any suitable I/O device for entering information into a mobile computing device. Examples for I/O device 506 may include an alphanumeric keyboard, a numeric keypad, a touch pad, input keys, buttons, switches, rocker switches, voice recognition device and software, and so forth. Information also may be entered into device 500 by way of microphone. Such information may be digitized by a voice recognition device. The embodiments are not limited in this context.

Device 500 may comprise a user interface 510 that may be displayed on display 504 similar to user interface 100 or 322 discussed herein.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system, comprising:
a device connected to a network, wherein the device to receive and store screen apparatus content, wherein the device to receive protected content, wherein the device to display the stored screen apparatus content overlayed on the protected content via a user interface on a display device, and wherein the protected content is not altered by a user.

2. The system of claim 1, wherein the screen apparatus content is received at the device via an Internet Protocol (IP) connection.

3. The system of claim 1, wherein the screen apparatus content is received at the device via a Universal Serial Bus (USB) connection.

4. The system of claim 1, wherein the protected content is broadcast content.

5. The system of claim 1, wherein the user interface comprises a screen apparatus content section and a protected content section, the screen apparatus content section to display the screen apparatus content and the protected content section to display the protected content.

6. The system of claim 5, wherein the screen apparatus content and the screen apparatus content section may be customized by a user.

7. The system of claim 1, wherein the device is the source of the protected content.

8. The system of claim 1, wherein the device is a pass-through device for the protected content.

9. A method, comprising:
receiving screen apparatus content at a device connected to a network;
storing the screen apparatus content on the device;
receiving protected content at the device; and
displaying the stored screen apparatus content overlayed on the protected content via a user interface on a display device, wherein the protected content is not altered by a user.

10. The method of claim 9, wherein the screen apparatus content is received at the device via an Internet Protocol (IP) connection.

11. The method of claim 9, wherein the screen apparatus content is received at the device via a Universal Serial Bus (USB) connection.

12. The method of claim 9, wherein the protected content is broadcast content.

13. The method of claim 9, wherein the user interface comprises a screen apparatus content section and a protected content section, the screen apparatus content section to display the screen apparatus content and the protected content section to display the protected content.

14. The method of claim 13, wherein the screen apparatus content and the screen apparatus content section may be customized by a user.

15. The method of claim 9, wherein the device is the source of the protected content.

16. The method of claim 9, wherein the device is a pass-through device for the protected content.

17. A machine-readable storage medium containing instructions which, when executed by a processing system, cause the processing system to perform a method, the method comprising:
receiving screen apparatus content at a device connected to a network;
storing the screen apparatus content on the device;
receiving protected content at the device; and
displaying the stored screen apparatus content overlayed on the protected content via a user interface on a display device, wherein the protected content is not altered by a user.

18. The machine-readable storage medium of claim 17, wherein the screen apparatus content is received at the device via an Internet Protocol (IP) connection.

19. The machine-readable storage medium of claim 17, wherein the screen apparatus content is received at the device via a Universal Serial Bus (USB) connection.

20. The machine-readable storage medium of claim 17, wherein the protected content is broadcast content.
